(19) United States
(12) Patent Application Publication
(10) Pub. No.: US 2007/0090554 A1
(43) Pub. Date: Apr. 26, 2007

(54) Panel molding method and apparatus

(76) Inventors: Rick Wykoff, Commerce, MI (US); Dan Houston, Dearborn, MI (US); Stan Staniszewski, Grosse Pointe Woods, MI (US); Ron Cooper, Canton, MI (US); Elisabeth Berger, Farmington Hills, MI (US); Stanley Iobst, Troy, MI (US)

Correspondence Address: REISING, ETHINGTON, BARNES, KISSELLE, P.C., P O BOX 4390, TROY, MI, 48099-4390, US

(21) Appl. No.: 11/259,479

(22) Filed: Oct. 26, 2005

(51) Int. Cl. B27N 3/00; B29C 33/10

(52) U.S. Cl. 264/102; 264/109; 425/DIG. 60; 425/405.1

(57) ABSTRACT

A method and apparatus for molding panels, the apparatus including upper and lower mold dies, a sprayer that sprays resin onto the lower mold die, and a wiper seal ring that's disposed in a position to form a vacuum chamber between the upper and lower mold dies as the mold dies are moving together from an initial sealing position to a closed position. A vacuum source draws air from the vacuum chamber as the mold dies are closing. The vacuum draws trapped air from within the sprayed-on resin to provide a superior class-A surface.

### STATEMENT REGARDING FEDERALLY SPONSORED RESEARCH OR DEVELOPMENT

The U.S. government has a paid-up license in this invention and the right in limited circumstances to require the patent owner to license others on reasonable terms as provided for by the terms of Cooperative Agreement No. DE-FC05-02-OR22910 awarded by the Department of Energy.

### CROSS-REFERENCES TO RELATED APPLICATIONS

Not Applicable

### BACKGROUND OF THE INVENTION

1. Field of the Invention

This invention relates generally to apparatus for molding plastic parts.

2. Description of the Related Art Including Information Disclosed Under 37 CFR 1.97 and 1.98

Certain automotive body panels such as exterior or “class A” automotive body panels require surface quality free from visible defects and voids. It is known to produce superior finishes on molded plastic automobile body panels by using a vacuum to draw trapped gas bubbles from a resin substrate during the molding process. For example, U.S. Pat. No. 6,805,546 issued 19 Oct. 2004 to Hahn et al., discloses a panel compression molding apparatus including a stationary lower mold die having a contoured upper face for supporting a charge of sheet molding compound and an upper mold die having a lower face shaped to complement the contour of the upper face of the lower mold die. The upper mold die is supported on a press platen for vertical reciprocal movement between an open position spaced from the lower mold die and a closed position where the upper face of the lower mold die and the lower face of the upper mold die define a mold cavity into which the charge of sheet molding compound is compressed. A perimeter seal is carried by the press platen and includes a compression seal ring that engages a sealing surface on an apron surrounding and attached to the lower mold die, the compression seal ring engaging the sealing surface as the platen carries the upper mold die and perimeter seal downward through an initial sealing position between the open and closed positions forming a vacuum chamber between the upper and lower mold dies. The perimeter seal further includes a wiper seal ring that is slidably disposed against a vertical outer wall of the upper mold die. The wiper seal ring maintains sliding sealing contact against and around the upper mold die as the upper mold die continues to move downward from the initial sealing position to the closed position. A vacuum system draws air from the vacuum chamber through a gap between respective peripheral lips of the upper and lower mold dies. The vacuum system includes a vacuum source valve connected between a vacuum source and the vacuum chamber. The Hahn et al. molding apparatus also includes a vacuum release system having four kicker cylinders positioned to push four corresponding kicker rods up against extending arms of the perimeter seal to break the seal and release the vacuum following curing. However, a panel molding apparatus constructed according to the Hahn patent is unable to provide a panel comprising both resin and chopped fibers, to prevent particulate contamination of the vacuum system, to maintain a vacuum chamber seal using only a single seal ring and no moving seal assembly parts, or to release the vacuum in the vacuum chamber without having to forcibly disengage the seal.

What is needed is an apparatus that molds panels, such as automotive exterior body panels, to have superior finishes and that does so without having to preform and position charges of sheet molding compound in a press. What is also needed is such an apparatus that is configured to form panels having superior finishes from molding compounds containing both resin and reinforcement material. It would also be desirable for such an apparatus to be capable of preventing particulates such as chopped fibers from contaminating the vacuum system, that is further capable of maintaining a vacuum seal between moving mold dies without requiring multiple seals or moving seal assembly parts, and that need not forcibly disengage the vacuum seal to release the vacuum in the vacuum chamber.

### BRIEF SUMMARY OF THE INVENTION

According to the invention, an apparatus is provided for molding panels from sprayed-on resin in a vacuum environment to provide superior surface qualities by removing trapped gas from the resin. The apparatus includes a lower mold die having a contoured upper face and an upper mold die having a lower face, the upper and lower mold dies being supported for relative reciprocal motion between an open position displaced from one another and a closed position where the mold dies abut one another and the upper face of the lower mold die and the lower face of the upper mold die define a mold cavity. A sprayer is positioned to spray resin onto the upper face of the lower mold die. A wiper seal ring is positioned and configured to be disposed between and in sealing engagement with respective sealing surfaces of the mold dies when the mold dies are positioned at and between the closed position and an initial sealing position between the open and closed positions, forming a vacuum chamber between the upper and lower mold dies. A vacuum source is connectable to the vacuum chamber and configured to draw air from the vacuum chamber.

According to another aspect of the invention the sprayer is configured to co-spray a mixture of resin and reinforcement material onto the upper face of the lower mold die to provide a panel with superior strength.

According to another aspect of the invention the sprayer is configured to co-spray a mixture of urethane resin and chopped glass fibers onto the upper face of the lower mold die.

According to another aspect of the invention the wiper seal ring is carried by one of the mold dies in a position to be in engagement with the other mold die at and between the initial sealing and the closed positions of the mold dies to allow the vacuum chamber to be evacuated as the mold is closing using only a single seal ring and no moving seal assembly parts.

According to another aspect of the invention the wiper seal ring is carried on a vertical outer sealing surface of the upper mold die in a position to be in engagement with a vertical inner sealing surface of the lower mold die at and between the initial sealing position and the closed position of the mold dies.

According to another aspect of the invention the vacuum source is connected to the vacuum chamber by a port in one of the upper mold die and the lower mold die so that gas can continue to be drawn from the vacuum chamber after the mold dies have closed.

According to another aspect of the invention the vacuum source is connected to the vacuum chamber by a port in the lower mold die to avoid complications arising from the movement of the upper mold die.

According to another aspect of the invention a vacuum release vent is connected between the vacuum chamber and a gas source, the vacuum release vent being actuable to release the vacuum from the vacuum chamber by admitting air to the vacuum chamber to obviate the need to physically disengage the seal.

According to another aspect of the invention a vacuum source valve is connected between the vacuum chamber and the vacuum source and is operable to alternately provide and close-off fluid communication between the vacuum chamber and the vacuum source so that a vacuum source accumulator can be charged while the mold is open and to allow gas to be drawn rapidly from the vacuum chamber.

According to another aspect of the invention a vacuum initiation switch is disposed in a position to detect when the mold dies are in a predetermined vacuum initiation position between the initial sealing position and the closed position to automatically initiate fluid communication between the vacuum source and the vacuum chamber when the mold dies move past the predetermined vacuum initiation position.

According to another aspect of the invention a filter is connected between the vacuum source and the vacuum chamber and is configured to remove particulates from evacuated air to prevent damage to or fouling of the vacuum system.

The invention also includes a method for molding panels from co-sprayed urethane and chopped glass fiber. According to this method a mold assembly is provided that includes upper and lower mold dies supported for relative reciprocal motion between an open position displaced from one another and a closed position where the mold dies abut one another and where a contoured upper face of the lower mold die and a corresponding contoured lower face of the upper mold die define a mold cavity. A mixture of resin and reinforcement material is then co-sprayed onto the upper face of the lower mold die, the mold dies are moved from the open position toward the closed position, trapped gas is drawn from the mixture of resin and reinforcement material, and the mold dies are moved into the closed position.

According to another aspect of the inventive method, the mold assembly is provided with the wiper seal ring carried by one of the upper mold die and the lower mold die in a position to engage and slide along the sealing surface of the other mold die. In addition, the step of moving the mold dies includes maintaining sliding sealing contact of the wiper seal ring against the sealing surface of the other mold die as the mold dies continue to move from the initial sealing position to the closed position.

According to another aspect of the inventive method, the mold assembly is provided with a filter connected between the vacuum source and the vacuum chamber. In addition, the step of drawing air from the vacuum chamber includes removing particulates from evacuated air by drawing the air through the filter such that reinforcement fibers and other particulates are trapped in the filter.

According to another aspect of the inventive method, the step of co-spraying a mixture of resin and reinforcement material onto the upper face of the lower mold die includes spraying urethane resin onto the upper face of the lower mold die.

According to another aspect of the inventive method, the step of co-spraying a mixture of resin and reinforcement material onto the upper face of the lower mold die includes spraying chopped glass fibers onto the upper face of the lower mold die.

According to another aspect of the inventive method, the step of moving the mold dies from the open position toward the closed position includes supporting the upper mold die on a press platen and actuating the platen to carry the upper mold die downward toward the closed position.

According to another aspect of the inventive method, the step of drawing trapped air from the mixture of resin and reinforcement material includes forming a vacuum chamber between the upper and lower mold dies and drawing air from the vacuum chamber

According to another aspect of the inventive method, the step of forming a vacuum chamber includes providing a wiper seal ring positioned and configured to be disposed between and in sealing engagement with respective sealing surfaces of the mold dies when the mold dies are positioned at and between the closed position and an initial sealing position between the open and closed positions.

According to another aspect of the inventive method, the step of drawing air from the vacuum chamber includes providing a vacuum source connectable to the vacuum chamber, connecting a vacuum source valve between the vacuum chamber and the vacuum source in a position to alternately provide and close-off fluid communication between the vacuum chamber and the vacuum source, positioning a vacuum initiation switch to detect when the mold dies are in a predetermined vacuum initiation position between the initial sealing position and the closed position, causing the vacuum source valve to open when the upper mold die moves downward past the vacuum initiation position and actuates the vacuum initiation switch by closing an electrical circuit powering the vacuum source valve to an open position and providing fluid communication between the vacuum source and the vacuum chamber.

According to another aspect of the inventive method, the step of drawing air from the vacuum chamber includes pumping the vacuum surge tanks to a specified level of vacuum before causing the vacuum source valve to open.

According to another aspect of the inventive method, the step of continuing to move the mold dies into the closed position includes, once the mold has closed, allowing the mixture of resin and reinforcement material to cure, then closing the vacuum source valve and venting the mold to atmospheric pressure by opening a vacuum vent valve.

According to another aspect of the inventive method, the step of providing a mold assembly includes the wiper seal ring being carried by one of the upper mold die and the lower mold die in a position to engage and slide along the sealing surface of the other mold die, and the step of moving the mold dies includes maintaining sliding sealing contact of the wiper seal ring against the sealing surface of the other mold die as the mold dies continue to move from the initial sealing position to the closed position.

### BRIEF DESCRIPTION OF THE SEVERAL VIEWS OF THE DRAWINGS

These and other features and advantages of the invention will become apparent to those skilled in the art in connection with the following detailed description and drawings, in which:

FIG. 1 is a schematic cross-sectional front view of a panel molding apparatus constructed according to the invention with upper and lower mold dies of the apparatus shown in an open position with resin and fiber being sprayed onto an upper surface of the lower mold die;

FIG. 2 is a schematic cross-sectional front view of the panel molding apparatus of FIG. 1 with the upper and lower mold dies of the apparatus shown in an initial sealing position with a wiper seal strip supported by the upper mold die contacting the lower mold die and closing a vacuum chamber defined by the upper and lower mold dies;

FIG. 3 is a schematic cross-sectional front view of the panel molding apparatus of FIG. 1 with the upper and lower mold dies of the apparatus shown in a vacuum initiation position with gas being drawn from a vacuum chamber defined by the upper and lower mold dies;

FIG. 4 is a schematic cross-sectional front view of the panel molding apparatus of FIG. 1 with the upper and lower mold dies of the apparatus shown in a closed position.

FIG. 5 is a schematic cross-sectional front view the panel molding apparatus of FIG. 1 with the upper and lower mold dies of the apparatus returned to the open position and with a molded and cured panel removed from the apparatus.

FIG. 6 is a flow chart detailing the process shown in FIGS. 1-4.

### DETAILED DESCRIPTION OF INVENTION EMBODIMENT(S)

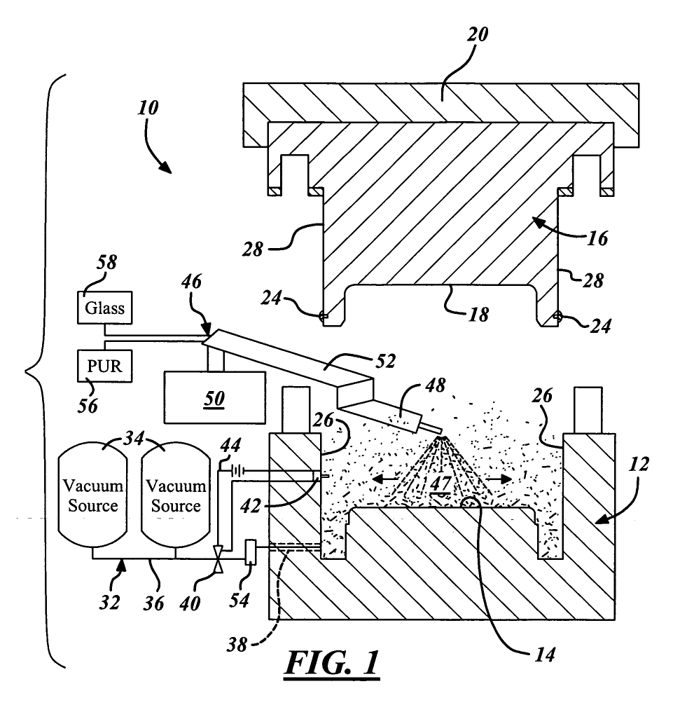

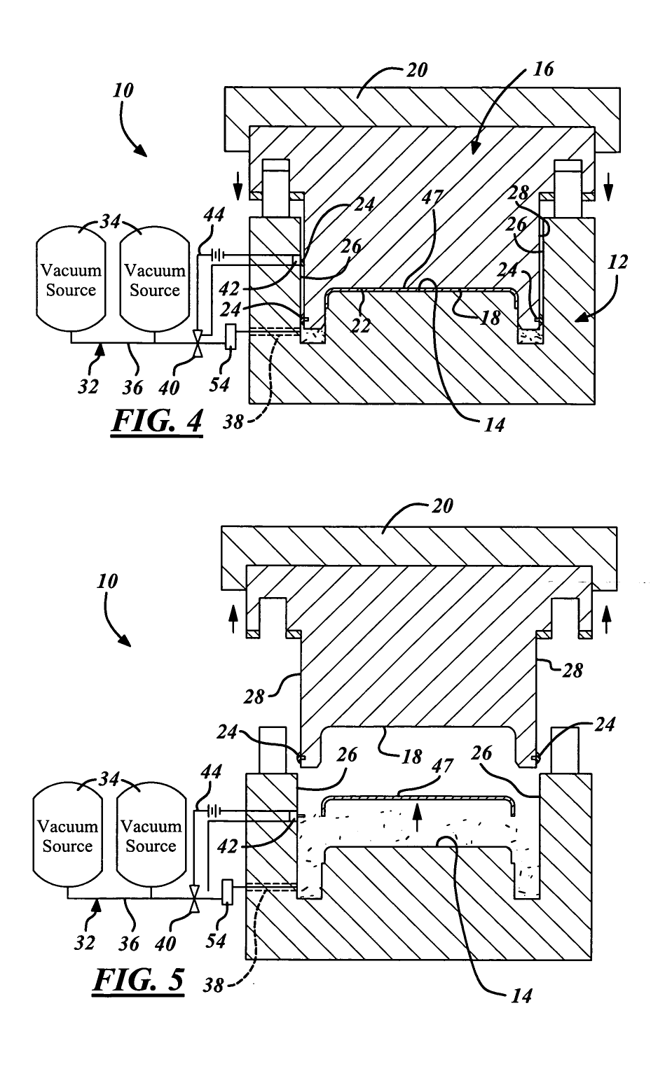

An apparatus for compression molding body panels is generally shown at 10 in FIGS. 1-4. The apparatus 10 comprises a compression mold 10 including a stationary lower mold die 12 or mold core having a generally convex contoured upper face 14 and an upper mold die 16 or mold cavity having a generally concave lower face 18 disposed opposite and shaped to complement the contour of the upper face 14 of the lower mold die 12. The upper mold die 16 is supported on a press platen 20 that carries the upper mold die 16 through reciprocal motion between an upper open position shown in FIG. 1 and a lower closed position shown in FIG. 4. In the upper open position shown in FIG. 1, the upper mold die 16 is displaced from the lower mold die 12 and in the lower closed position shown in FIG. 4 the mold dies 12, 16 abut one another and the upper face 14 of the lower mold die 12 and the lower face 18 of the upper mold die 16 define a mold cavity 22.

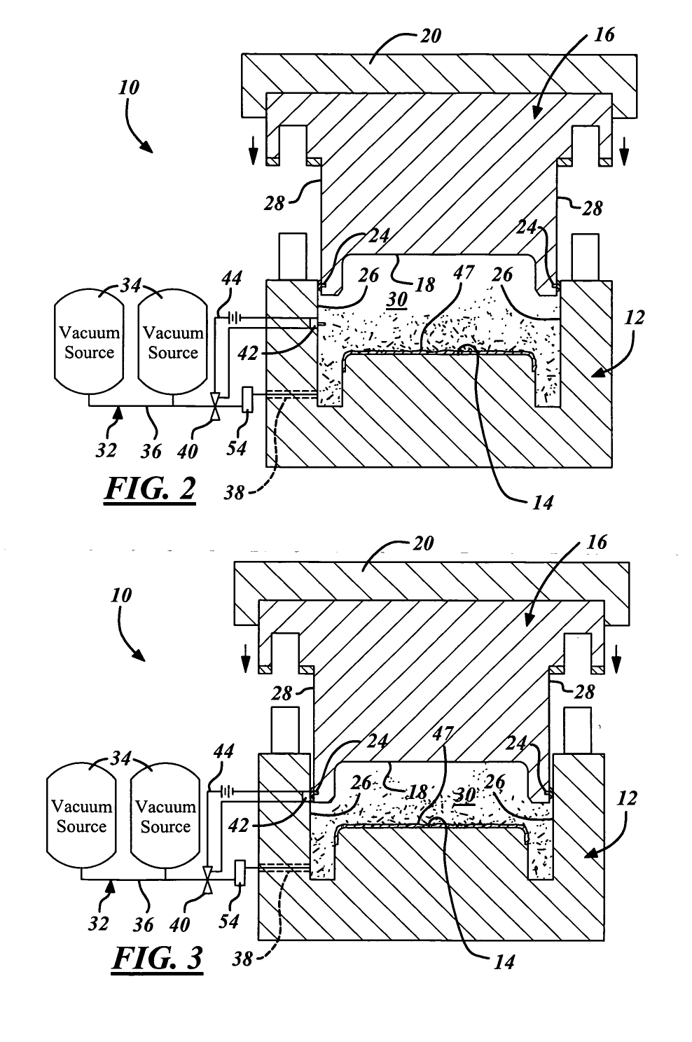

The apparatus 10 also includes a wiper seal ring 24 positioned and shaped to be disposed between and in sealing engagement with respective sealing surfaces 26, 28 of the mold dies 12, 16 when the mold dies 12, 16 are positioned at and between the closed position shown in FIG. 4 and an initial sealing position between the open and closed positions as shown in FIG. 2. At the initial sealing position the mold dies 12, 16 and the wiper seal ring 24 cooperate to form a vacuum chamber 30 between the upper and lower mold dies 12.

A vacuum source 32 is connected to the vacuum chamber 30 and is actuable to draw air from the vacuum chamber 30. The wiper seal ring 24 is carried on a vertical outer sealing surface 28 of the upper mold die 16 in a position to be in engagement with a vertical inner sealing surface 26 of the lower mold die 12 at and between the initial sealing and the closed position of the mold dies 12, 16 as the upper and lower mold dies 12 move toward one another. In other words, the upper mold die 16 carries the wiper seal ring 24 in a position to slide along the inner sealing surface 26 of the lower mold die 12, maintaining the vacuum chamber 30 in a sealed state as the mold dies 12, 16 move from the initial sealing position shown in FIG. 2 to the closed position shown in FIG. 4.

The vacuum source 32 includes a pair of vacuum surge tanks 34 connected to the vacuum chamber 30 by vacuum lines 36 leading to ports 38 in the lower mold die 12. In other embodiments there could be only one surge tank or any suitable number of surge tanks connected to the vacuum chamber 30 by respective vacuum lines. A vacuum source valve 38 is connected between the vacuum chamber 30 and the vacuum source 32 and is operable to alternately provide and close-off fluid communication between the vacuum chamber 30 and the vacuum source 32. A vacuum release vent 40 is connected between the vacuum chamber 30 and an ambient air source. The vacuum release vent 40 is actuable to release the vacuum from the vacuum chamber 30 by admitting air to the vacuum chamber 30.

A vacuum initiation switch 42 is disposed in a position to detect when the mold dies 12, 16 are in a predetermined vacuum initiation position shown in FIG. 3. The vacuum initiation position is disposed between the initial sealing position shown in FIG. 2 and the closed position shown in FIG. 4. This detection occurs when the upper mold die 16 moves downward past the vacuum initiation position where the passage of the upper mold die 16 actuates the vacuum initiation switch 42. Actuation of the vacuum initiation switch 42 closes an electrical circuit 44 powering the vacuum source valve 38 to an open position and providing fluid communication between the vacuum source 32 and the vacuum chamber 30.

As shown in FIG. 1, the apparatus 10 also includes a sprayer 46 constructed and positioned to co-spray a mixture 47 of urethane resin and chopped glass fibers onto the upper face 14 of the lower mold die 12 when the upper mold die 16 is in the open position. The sprayer 46 includes a spray head 48 movably supported on a sprayer base 50 by a robot arm 52. This arrangement is well known in the art and is useful for moving a spray head into and out of position within an open mold.

As shown in FIGS. 1-5, a particulate trap or filter 54 is connected between the vacuum source 32 and the vacuum chamber 30 in a position to remove particulates such as cut glass fibers from evacuated air. The filter 54 traps chopped glass fibers remaining from the co-spraying of resin and chopped glass fibers and prevents the fibers from entering the vacuum source 32.

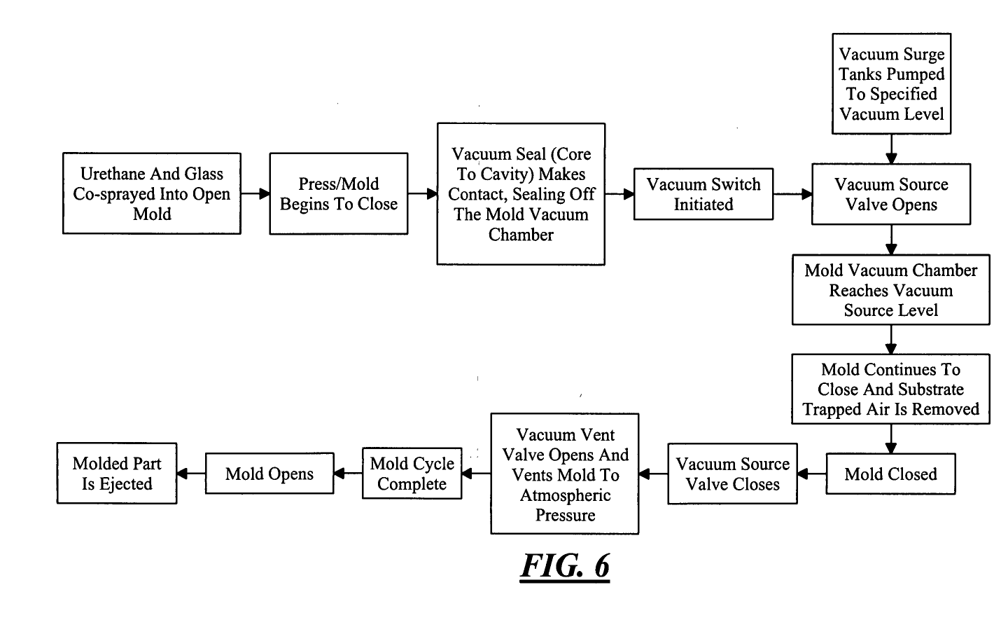

In practice, and as shown in FIG. 6, the apparatus 10 is used to form plastic body panels by first pumping the vacuum surge tanks 34 to a specified level of vacuum and then causing the sprayer 46 to co-spray a mixture 47 of urethane resin and a reinforcement material such as chopped glass fibers onto the upper face 14 of the lower mold die 12. The sprayer 46 draws the urethane resin from a resin source 56 and draws glass fiber from a glass fiber source 58 as shown in FIG. 1. In other embodiments the reinforcement material may be of any suitable type to include carbon fibers or natural fibers such flax, jute, hemp, or ramie. Once the mixture 47 of urethane resin and chopped glass has been sprayed onto the upper face 14 of the lower mold die 12, the platen 20 is actuated to carry the upper mold die 16 downward from the open position toward the closed position.

When the upper mold die 16 reaches the initial sealing position as shown in FIG. 2, the wiper seal ring 24 carried by the upper mold die 16 engages an upper edge 60 of the sealing surface 26 of the lower mold die 12. At this point, the vacuum chamber 30 is defined and sealed and remains so as the upper mold die 16 continues to descend toward the closed position, the volume of the vacuum chamber 30, of course, decreasing, in the process. Sliding sealing contact of the wiper seal ring 24 is maintained against and around a vertical inner sealing surface 26 of the lower mold die 12 as the upper mold die 16 continues to move from the initial sealing position to the closed position against the lower mold die 12.

As the upper mold die 16 continues to descend it reaches the vacuum initiation position as shown in FIG. 3. As the upper mold die 16 passes the vacuum initiation position trapped air begins to be drawn from the sprayed-on mixture 47 of resin and fibers by drawing air from the vacuum chamber 30. Air is drawn from the vacuum chamber 30 by providing fluid communication between the vacuum surge tanks 34 and the mold vacuum chamber 30. Fluid communication is provided when the vacuum source valve 38 is opened in response to the upper mold die's actuation of the vacuum initiation switch 42. Actuation of the vacuum initiation switch 42 closes the electrical circuit 44 powering the vacuum source valve 38 to an open position. The evacuated air is drawn through the particulate trap or filter 54 disposed between the vacuum source 32 and the vacuum chamber 30, removing cut glass fibers and other particulate matter from the evacuated air and trapping the fibers and other particulates in the filter 54.

The upper mold die 16 continues to move into the closed position shown in FIG. 4, where the sprayed-on mixture 47 of resin and fibers is compressed into a desired shape within the mold cavity 22 defined by the closed mold dies 12, 16. The compressed mixture 47 of resin and fibers is allowed sufficient time to cure, then the vacuum source valve 38 is closed and the vacuum vent 40 vale is opened to vent 40 the mold to atmospheric pressure. The mold is then opened, as shown in FIG. 5, and the part formed from the mixture 47 of resin and fibers is removed or ejected.

According to the invention vacuum compression molding allows plastic automotive body panels to be made that have the strength co-sprayed resin and fiber and high exterior surface quality free from visible defects and voids. The panels can be made using a compression mold 10 that requires only a single seal ring 24 and no moving seal assembly parts, and that allows air to be drawn from the mold vacuum chamber 30 even after the mold dies 12, 16 have closed. The filter 54 protects the vacuum source 32 from fiber contamination. To further improve panel surface quality the vacuum system is designed to allow air to be drawn rapidly from the vacuum chamber 30.

This description is intended to illustrate certain embodiments of the invention rather than to limit the invention. Therefore, it uses descriptive rather than limiting words.

Obviously, it's possible to modify this invention from what the description teaches. Within the scope of the claims, one may practice the invention other than as described.

What is claimed is:

1. A panel molding apparatus for molding panels, the apparatus comprising:
a lower mold die having a contoured upper face;
an upper mold die having a lower face, the upper and lower mold dies being supported for relative reciprocal motion between an open position displaced from one another and a closed position where the mold dies abut one another and the upper face of the lower mold die and the lower face of the upper mold die define a mold cavity;
a wiper seal ring positioned and configured to be disposed between and in sealing engagement with respective sealing surfaces of the mold dies when the mold dies are positioned at and between the closed position and an initial sealing position between the open and closed positions, forming a vacuum chamber between the upper and lower mold dies;
a vacuum source connectable to the vacuum chamber and configured to draw air from the vacuum chamber; and
a sprayer positioned to spray resin onto the upper face of the lower mold die.

2. A panel molding apparatus as defined in claim 1 in which the sprayer is configured to co-spray a mixture of resin and reinforcement material onto the upper face of the lower mold die.

3. A panel molding apparatus as defined in claim 1 in which the sprayer is configured to co-spray a mixture of urethane resin and chopped glass fibers onto the upper face of the lower mold die.

4. A panel molding apparatus as defined in claim 1 in which the wiper seal ring is carried by one of the mold dies in a position to be in engagement with the other mold die at and between the initial sealing and the closed positions of the mold dies.

5. A panel molding apparatus as defined in claim 4 in which the wiper seal ring is carried on a vertical outer sealing surface of the upper mold die in a position to be in engagement with a vertical inner sealing surface of the lower mold die at and between the initial sealing position and the closed position of the mold dies.

6. A panel molding apparatus as defined in claim 1 in which the vacuum source is connected to the vacuum chamber by a port in one of the upper mold die and the lower mold die.

7. A panel molding apparatus as defined in claim 6 in which the vacuum source is connected to the vacuum chamber by a port in the lower mold die.

8. A panel molding apparatus as defined in claim 1 in which a vacuum release vent is connected between the vacuum chamber and a gas source, the vacuum release vent being actuable to release the vacuum from the vacuum chamber by admitting air to the vacuum chamber.

9. A panel molding apparatus as defined in claim 1 in which a vacuum source valve is connected between the vacuum chamber and the vacuum source and is operable to alternately provide and close-off fluid communication between the vacuum chamber and the vacuum source.

10. A panel molding apparatus as defined in claim 1 in which a vacuum initiation switch is disposed in a position to detect when the mold dies are in a predetermined vacuum initiation position between the initial sealing position and the closed position.

11. A panel molding apparatus as defined in claim 1 in which a filter is connected between the vacuum source and the vacuum chamber and is configured to remove particulates from evacuated air.

12. A method for molding panels from co-sprayed resin and reinforcement material, the method including the steps of:
providing a mold assembly including upper and lower mold dies supported for relative reciprocal motion between an open position displaced from one another and a closed position where the mold dies abut one another and where a contoured upper face of the lower mold die and a corresponding contoured lower face of the upper mold die define a mold cavity; co-spraying a mixture of resin and reinforcement material onto the upper face of the lower mold die;
moving the mold dies from the open position toward the closed position;
drawing trapped air from the mixture of resin and reinforcement material; and
continuing to move the mold dies into the closed position.

13. The method of claim 12 in which:
the step of providing a mold assembly includes the wiper seal ring being carried by one of the upper mold die and the lower mold die in a position to engage and slide along the sealing surface of the other mold die; and
the step of moving the mold dies includes maintaining sliding sealing contact of the wiper seal ring against the sealing surface of the other mold die as the mold dies continue to move from the initial sealing position to the closed position.

14. The method of claim 12 in which:
the step of providing a mold assembly includes connecting a filter between the vacuum source and the vacuum chamber; and
the step of drawing air from the vacuum chamber includes removing particulates from evacuated air by drawing the air through the filter.

15. The method of claim 12 in which the step of co-spraying a mixture of resin and reinforcement material includes spraying urethane resin onto the upper face of the lower mold die.

16. The method of claim 12 in which the step of co-spraying a mixture of resin and reinforcement material includes spraying chopped glass fibers onto the upper face of the lower mold die.

17. The method of claim 12 in which the step of moving the mold dies from the open position toward the closed position includes supporting the upper mold die on a press platen and actuating the platen to carry the upper mold die downward toward the closed position.

18. The method of claim 12 in which the step of drawing trapped air from the mixture of resin and reinforcement material includes:
forming a vacuum chamber between the upper and lower mold dies; and
drawing air from the vacuum chamber.

19. The method of claim 18 in which the step of forming a vacuum chamber includes providing a wiper seal ring positioned and configured to be disposed between and in sealing engagement with respective sealing surfaces of the mold dies when the mold dies are positioned at and between the closed position and an initial sealing position between the open and closed positions.

20. The method of claim 19 in which the step of drawing air from the vacuum chamber includes:
providing a vacuum source connectable to the vacuum chamber;
connecting a vacuum source valve between the vacuum chamber and the vacuum source in a position to alternately provide and close-off fluid communication between the vacuum chamber and the vacuum source;
positioning a vacuum initiation switch to detect when the mold dies are in a predetermined vacuum initiation position between the initial sealing position and the closed position; and
causing the vacuum source valve to open by causing the upper mold die to move downward past the vacuum initiation position, actuating the vacuum initiation switch to close an electrical circuit powering the vacuum source valve to an open position and providing fluid communication between the vacuum source and the vacuum chamber.

21. The method of claim 18 in which the step of continuing to move the mold dies into the closed position includes:
once the mold has closed, allowing the mixture of resin and reinforcement material to cure; then
closing the vacuum source valve and venting the vacuum chamber to atmospheric pressure by opening a vacuum vent valve.
